(19) United States
(12) Patent Application Publication
(10) Pub. No.: US 2016/0109646 A1
(43) Pub. Date: Apr. 21, 2016

(54) DISPLAY DEVICE

(71) Applicant: SAMSUNG DISPLAY CO., LTD., Yongin-si (KR)

(72) Inventors: Jeonghun GO, Asan-si (KR); Moonshik KANG, Yongin-si (KR); Yongsik HWANG, Yongin-si (KR)

(21) Appl. No.: 14/738,027

(22) Filed: Jun. 12, 2015

(30) Foreign Application Priority Data
Oct. 20, 2014 (KR) 10-2014-0141912

(51) Int. Cl. F21V 8/00

(52) U.S. Cl. CPC G02B 6/0083; G02B 6/0086; G02B 6/0085

(57) ABSTRACT

A display device includes: a display panel; a printed circuit board (PCB) disposed on at least a side portion of the display panel and including a plurality of circuit layers; a bottom chassis accommodating the display panel therein; and at least one flange protruding outwardly of the bottom chassis. At least one of the plurality of circuit layers has at least one groove, and the flange is inserted into the groove.

### CLAIM OF PRIORITY

This application makes reference to, incorporates the same herein, and claims all benefits accruing under 35 U.S.C. §119 from an application earlier filed in the Korean Intellectual Property Office on 20 Oct. 2014 and there duly assigned Serial No. 10-2014-0141912.

### BACKGROUND OF THE INVENTION

1. Field of the Invention

Aspects of embodiments of the present invention relate to a display device, and more particularly, to a display device having a relatively slim structure.

2. Description of the Related Art

Display devices are classified into liquid crystal displays (LCDs), organic light emitting diode displays (OLEDs), plasma display panels (PDPs), electrophoretic displays, and the like.

In order to drive such a display device, a printed circuit board (PCB) is connected to at least a side surface of the display device while having a chip on film (COF) or a tape carrier package (TCP) interposed therebetween. With a COF or a TCP including a circuit wire disposed on a panel formed of a relatively thin and pliable material, an electrical signal of the PCB may be applied to the display panel.

In general, the PCB is disposed to be closely attached to a base surface of a bottom chassis, and the COF or the TCP connecting the display panel and the PCB to one another is disposed to be bent towards a side surface of the bottom chassis.

Recently, in an effort to reduce a thickness of a display device, a slim-type display device in which a flange is provided in a bottom chassis to protrude outwardly thereof at predetermined intervals and a PCB is disposed on the flange to be coupled thereto has been garnering attention.

In such a slim-type display device, a flange and a PCB are coupled to one another through a screw coupling, and thereby, a space of the PCB for the screw coupling may be provided in the PCB. Since the space of the PCB for the screw coupling does not allow for the mounting of a surface mounting technology (SMT) component, a circuit pattern, and the like, on the PCB, a size of the PCB may be invariably increased.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY OF THE INVENTION

Embodiments of the present invention are directed to a display device capable of reducing a size of a printed circuit board (PCB) by modifying a coupling manner between a flange and the PCB.

According to an embodiment of the present invention, a display device may include a display panel; a PCB disposed on at least a side portion of the display panel and including a plurality of circuit layers; a bottom chassis accommodating the display panel therein; and at least one flange protruding outwardly of the bottom chassis, wherein at least one of the plurality of circuit layers has at least one groove, and the flange is inserted into the groove.

The groove may be formed in a direction perpendicular to a direction in which the plurality of circuit layers are stacked.

The PCB may be formed in a direction the same as the direction in which the plurality of circuit layers are stacked, and has a via-hole exposing portions of the flange.

The flange may have a width substantially the same as a width of the groove.

The display device may further include an adhesive member disposed between the groove and the flange.

The bottom chassis may include at least one of aluminum (Al), an Al alloy, magnesium (Mg), a Mg alloy, copper (Cu), a Cu alloy, and steel use stainless (SUS).

The flange may include at least one of Al, an Al alloy, Mg, a Mg alloy, Cu, a Cu alloy, and SUS.

The flange may be formed of a material the same as a material forming the bottom chassis.

According to another embodiment of the present invention, a display device may include a display panel; a PCB disposed on at least a side portion of the display panel, and including a plurality of circuit layers; a bottom chassis accommodating the display panel; and at least one flange coupled to the bottom chassis. At least one of the plurality of circuit layers has at least one groove, one end of the flange is inserted into the groove, and the other end of the flange is coupled to the bottom chassis.

The groove may be formed in a direction perpendicular to a direction in which the plurality of circuit layers are stacked.

The flange may have a width substantially the same as a width of the groove.

The PCB may be formed in a direction the same as the direction in which the plurality of circuit layers are stacked, and has a via-hole exposing portions of the flange.

The display device may further include an adhesive member disposed between the groove and the flange.

The bottom chassis may include at least one of Al, an Al alloy, Mg, a Mg alloy, Cu, a Cu alloy, and SUS.

The flange may include at least one of Al, an Al alloy, Mg, a Mg alloy, Cu, a Cu alloy, and SUS.

The flange may be formed of a material the same as a material forming the bottom chassis. to the inserting groove of the side wall portion.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view illustrating a display device according to an embodiment of the present invention;

FIG. 2 is a plan view illustrating a display device according to an embodiment of the present invention;

FIG. 3 is a view illustrating an enlarged portion “A” of FIG. 2;

FIG. 4 is a cross-sectional view taken along line I-I′ of FIG. 3;

FIG. 5 is a cross-sectional view taken along line II-II′ of FIG. 3;

FIG. 6 is an enlarged cross-sectional view illustrating a printed circuit board (PCB) according to an embodiment of the present invention;

FIG. 7 is an enlarged cross-sectional view illustrating a PCB and a flange according to an embodiment of the present invention; and

FIG. 8 is an enlarged cross-sectional view illustrating a PCB and a flange according to an embodiment of the present invention.

### DETAILED DESCRIPTION OF THE INVENTION

Advantages and features of the present invention and methods for achieving them will be made clear from embodiments described below in detail with reference to the accompanying drawings. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. The present invention is merely defined by the scope of the claims. Therefore, well-known constituent elements, operations and techniques are not described in detail in the embodiments in order to prevent the present invention from being obscurely interpreted. Like reference numerals refer to like elements throughout the specification.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first”, “second”, etc. may be used herein to describe various elements, these elements should not be limited by these terms. These terms are only used to distinguish one element from another element. Thus, a first element discussed below could be termed a second or third element without departing from the teachings of example embodiments, and in a similar manner thereto, second and third elements may be used interchangeably therewith.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Hereinafter, a display device according to an embodiment of the present invention will be described under the assumption that the display device is a liquid crystal display (LCD) device. However, according to embodiments, an organic light emitting diode (OLED) device or a plasma display device as well as an LCD device may also be used.

Throughout the specification, a display device will be described under the assumption that the display device is a liquid display panel; however, is not limited thereto, and the display panel may be an OLED panel.

Further, throughout the specification, the display device will be described under the assumption that the display device includes an edge-type backlight unit; however, is not limited thereto, and may also include a direct-type backlight unit or a corner-type backlight unit.

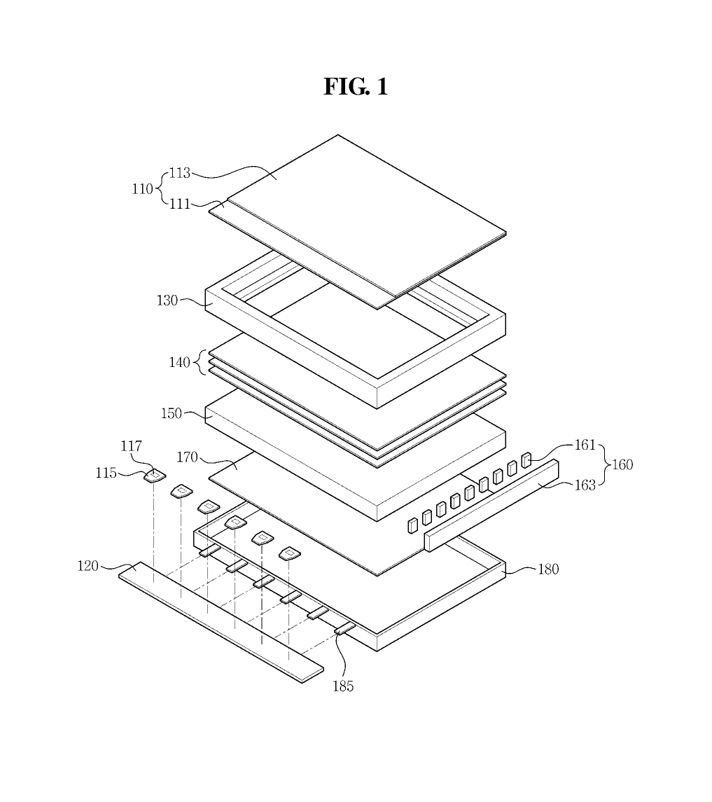

FIG. 1 is an exploded perspective view illustrating a display device according to an embodiment of the present invention.

In reference to FIG. 1, a display device according to an embodiment of the present invention may include a display panel 110, a printed circuit board (PCB) 120, a mold frame 130, an optical sheet 140, a light guide plate 150, a light source unit 160, a reflective sheet 170, and a bottom chassis 180.

Hereinafter, the mold frame 130, the optical sheet 140, the light guide plate 150, the reflective sheet 170, the bottom chassis 180, and the like, will be collectively referred to as a backlight unit.

The display panel 110 may be provided in a quadrangular planar shape displaying an image using a light source. The display panel 110 may include a first substrate 111, a second substrate 113 opposing the first substrate 111, and a liquid crystal layer (not illustrated) formed between the first and second substrates 111 and 113.

The first substrate 111 may include a plurality of pixel electrodes disposed in a matrix form, a thin-film transistor (TFT) applying a driving voltage to each of the plurality of pixel electrodes, and a signal line driving the pixel electrode and the thin film transistor.

The second substrate 113 may be disposed to oppose the first substrate 111, and may include a common electrode formed of a transparent conductive material, and a color filter. The color filter may be red, green, or blue color filter, by way of example.

The liquid crystal layer (not illustrated) may be interposed between the first and second substrates 111 and 113, and may be rearranged by an electric field formed between the pixel electrode and the common electrode. In detail, the rearranged liquid crystal layer may adjust a level of transmissivity of light emitted from the backlight unit, and the light having the adjusted level of transmissivity may pass through the color filter to thereby display an image outwardly.

In addition, although not illustrated in FIG. 1, a lower polarizing plate and an upper polarizing plate may further be disposed on a lower surface of the first substrate 111 and an upper surface of the second substrate 113, respectively. The upper polarizing plate and the lower polarizing plate may each have an area corresponding to an area of the display panel 110. The upper polarizing plate may pass through a predetermined component of polarized light from among externally supplied light, and may absorb or block the remainder of the externally supplied light. The lower polarizing plate may pass through a predetermined component of polarized light from among the light emitted from the backlight unit, and may absorb or block the remainder of the light emitted from the backlight unit.

The PCB 120 may be disposed on at least one side portion of the display panel 110. The PCB may provide various types of control signals and power signals. The PCB 120 may have a multilayer structure in which a plurality of circuit layers and a plurality of insulating layers are stacked. In addition, the PCB 120 may have a groove into which a flange, or the like, is inserted. A further description pertaining to the PCB 120 will be provided in greater detail below.

The display panel 110 and the PCB 120 may be electrically connected to one another by at least one flexible printed circuit board (FPCB) 115. The FPCB 115 may be a chip on film (COF) or a tape carrier package (TCP), and the number of FPCBs may vary based on a size, a driving manner, and the like, of the display panel 110.

A driving chip 117 may be mounted on the FPCB 115. The driving chip 117 may generate various driving signals for driving the display panel 110. The driving chip 117 may be a single chip in which a timing controller and a data driving circuit are integrated, and may also be referred to as a driver integrated circuit (IC), a source integrated circuit (IC), or the like.

The mold frame 130 may have a quadrangular loop shape, may support edges of the lower surface of the display panel 110, and may accommodate the optical sheet 140, the light guide plate 150, the light source unit 160, the reflective sheet 170, and the like, therein. The mold frame 130 may be formed as a single frame, however, may be formed to include a plurality of portions thereof to be subsequently assembled therefrom, as necessary. The mold frame 130 may be formed of a flexible material such as a plastic, and may be formed through an injection molding process, or the like.

The optical sheet 140 may be disposed on the light guide plate 150, and may serve to diffuse or collect light transmitted from the light guide plate 150. The optical sheet 140 may include a diffusion sheet, a prism sheet, and a protective sheet. The diffusion sheet, the prism sheet, and the protective sheet may be sequentially stacked on the light guide plate 150.

The prism sheet may collect light guided by the light guide plate 150, the diffusion sheet may disperse light collected by the prism sheet, and the protective sheet may protect the prism sheet. Light having passed through the protective sheet may be supplied to the display panel 110.

The light guide plate 150 may uniformly supply light supplied from the light source unit 160 to the display panel 110. The light guide plate 150 may have a quadrilateral planar shape; however, the shape of the light guide plate is not limited thereto, and in a case in which a light source such as a light emitting diode (LED) chip is used, the light guide plate 150 may have various shapes including a predetermined groove, a protrusion, or the like, based on a position of the light source.

The light guide plate 150 is described as a plate for ease of description; however, may be provided in a sheet or film shape to achieve slimness of the display device. In other words, the light guide plate 150 is to be understood as having a concept that includes not only a plate but also a film for guiding light.

The light guide plate 150 may be formed of a light-transmissive material such as, for example, an acrylic resin, such as polymethylmethacrylate (PMMA), or polycarbonate (PC) in order to guide light efficiently.

The light source unit 160 may include a light source 161 and a circuit substrate 163 on which the light source 161 is disposed.

The light source 161 may emit light toward an edge portion of the light guide plate 150, for example, a light-incident side surface of the light guide plate 150. The light source 161 may include at least one LED chip (not illustrated) and a package (not illustrated) for accommodating the LED chip. For example, the LED chip (not illustrated) may be a gallium nitride (GaN)-based LED chip emitting blue light.

The number of light source 161 may vary based on a size, luminance uniformity, and the like, of the display panel 110. The circuit substrate 163 may be a PCB or a metal PCB (MPCB).

The light source unit 160 may be provided on one, two, or four side surfaces of the light guide plate 150 based on the size, luminance uniformity, and the like, of the display panel 110. That is, the light source unit 160 may be provided at least one of edges of the light guide plate 150.

The reflective sheet 170 may be formed of, for example, polyethylene terephthalate (PET) to have reflectivity. One surface of the reflective sheet 170 may be coated with a diffusion layer containing, for example, titanium dioxide (TiO₂). In addition, the reflective sheet 170 may be formed of a material containing a metal, such as silver (Ag).

The bottom chassis 180 may serve to maintain a framework of the display device, and to protect a variety of components accommodated therein. The bottom chassis 180 may be formed of a material having rigidity and relatively excellent heat dissipation characteristics. For example, the bottom chassis 180 may include at least one of aluminum (Al), an Al alloy, magnesium (Mg), a Mg alloy, copper (Cu), a Cu alloy, and steel use stainless (SUS).

The bottom chassis 180 may include at least one flange 185 protruding outwardly. The flange 185 may have a form of a metal plate having a predetermined thickness.

The flange 185 may be formed to be integrated with the bottom chassis 180, or may be coupled to the bottom chassis 180 using a conventional coupling process such as a screw coupling process or a hook coupling process, or the like.

The flange 185 may be formed of a material the same as a material forming the bottom chassis 180. For example, the flange 185 may include at least one of Al, an Al alloy, Mg, a Mg alloy, Cu, a Cu alloy, and SUS.

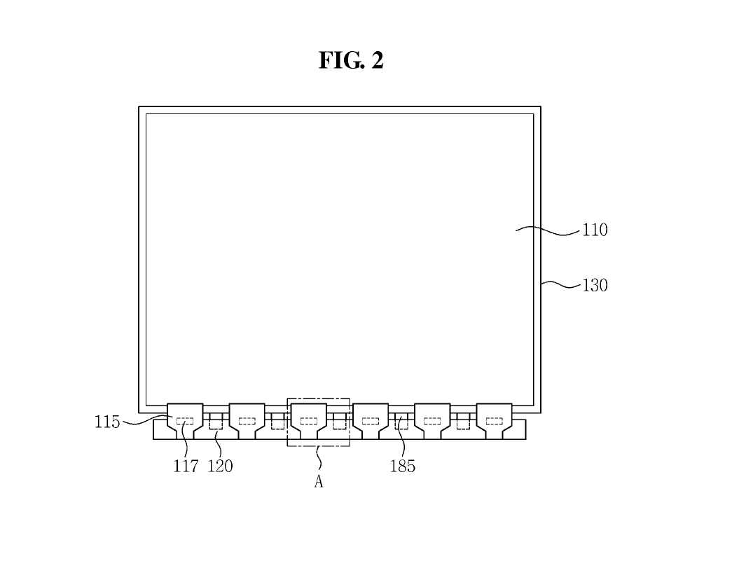

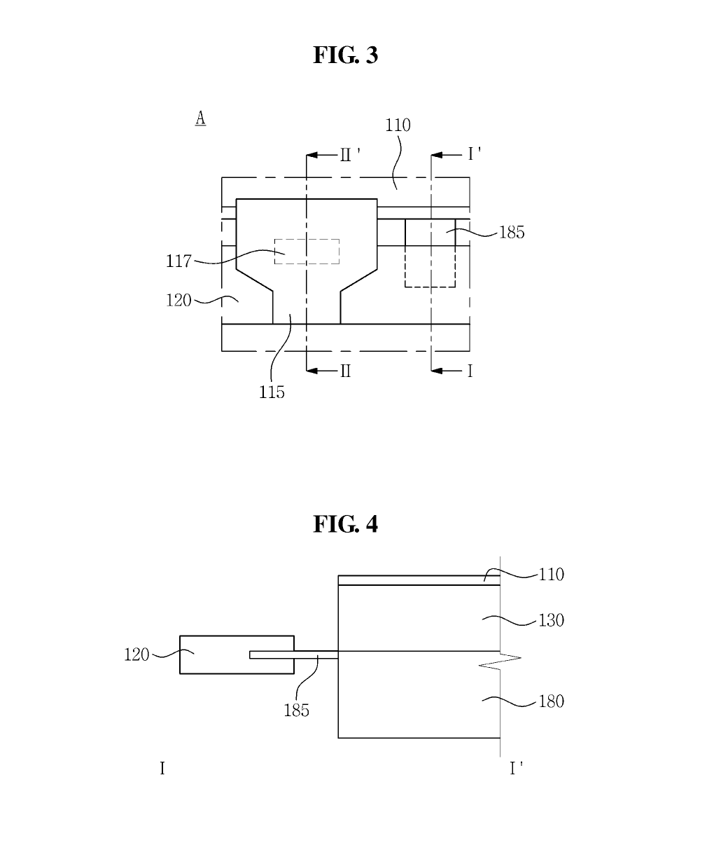

FIG. 2 is a plan view illustrating a display device according to an embodiment of the present invention; FIG. 3 is a view illustrating an enlarged portion “A” of FIG. 2; FIG. 4 is a cross-sectional view taken along line I-I′ of FIG. 3; and FIG. 5 is a cross-sectional view taken along line II-II′ of FIG. 3.

In reference to FIGS. 2 through 5, at least one flange 185 may be disposed on a side portion of the display panel 110 on which the PCB 120 is disposed. Although FIG. 2 depicts a case in which six flanges 185 are disposed by way of example, the disposition of the flange 185 is not limited thereto, and the number of flanges 185 and intervals therebetween may vary based on a size of the PCB 120.

The PCB 120 may have a multilayer structure in which a plurality of circuit layers and a plurality of insulating layers are stacked, and may have a groove formed in at least one of the plurality of circuit layers. The plurality of flanges 185 may be inserted into the groove formed in the PCB 120. A detailed description pertaining to the PCB having the multilayer structure and the groove formed in the PCB 120 will further be provided below.

The plurality of flanges 185 may be inserted into the PCB 120 to thereby support the PCB 120 and to be fixed thereto. In other words, since the PCB 120 may be fixed to the flange without an additional screw coupling, a space of the PCB 120 for allowing the mounting of components thereon may be increased, an overall size of the PCB 120 may be decreased.

In the case in which the flange 185 is formed to be integrated with the bottom chassis 180, the flange 185 protruding outwardly of the bottom chassis 180 may be inserted into the PCB 120.

In addition, in a case in which the flange 185 is formed to be separate from the bottom chassis 180, one end of the flange 185 may be coupled to the bottom chassis 180 in a state in which the other end of the flange 185 is inserted into the PCB 120.

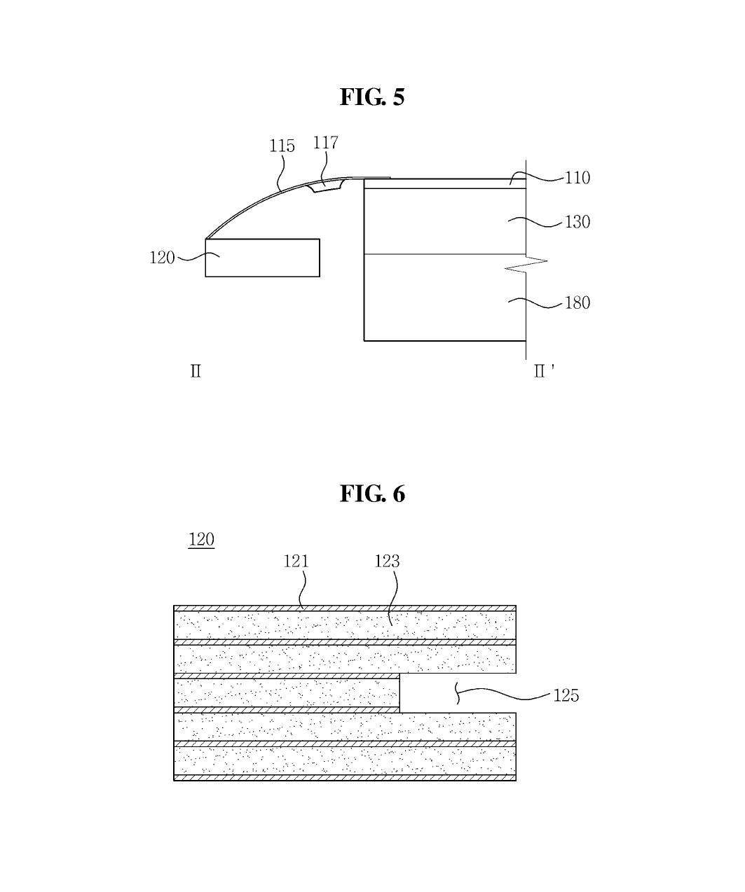

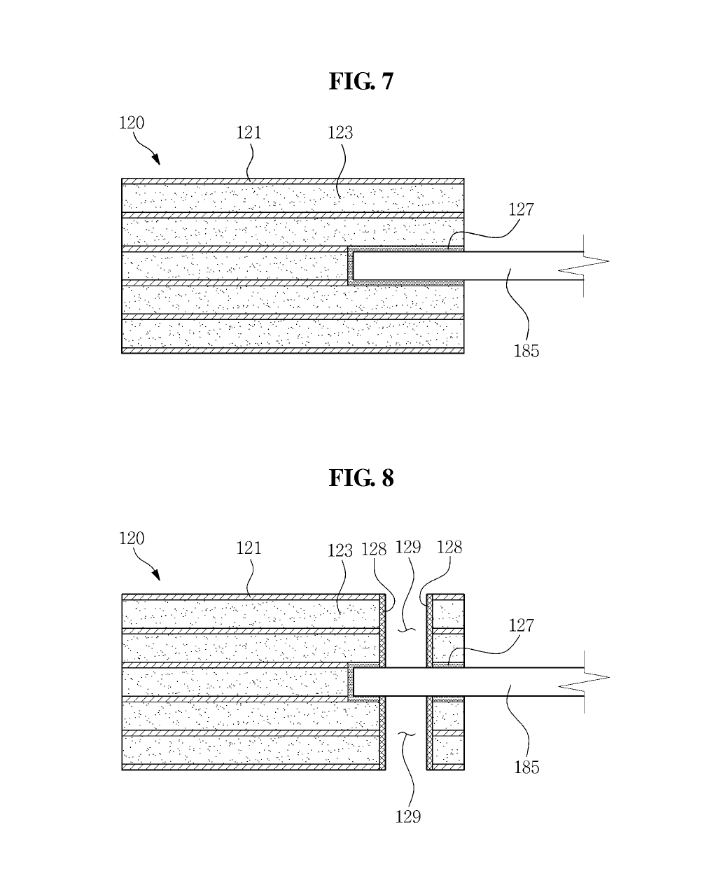

FIG. 6 is an enlarged cross-sectional view illustrating a printed circuit board (PCB) according to an embodiment of the present invention; and FIG. 7 is an enlarged cross-sectional view illustrating a PCB and a flange according to an embodiment of the present invention.

In reference to FIGS. 6 and 7, the PCB 120 may have a multilayer structure in which a plurality of circuit layers 121 and a plurality of insulating layers 123 are stacked in an alternating manner.

The PCB 120 may be formed by stacking the insulating layer 123 and the circuit layer 121 in an alternating manner, on one or both surfaces of a base substrate including two circuit layers 121 and an insulating layer 123 disposed between the two circuit layers 121.

Although FIGS. 6 and 7 depict a case in which the PCB 120 includes six circuit layers 121 and five insulating layers 123 each disposed between the circuit layers 121 by way of example, the number of circuit and insulating layers to be included in the PCB 120 is not limited thereto, and the PCB 120 may include a plurality of circuit layers and insulating layers. The insulating layer 123 may be formed of an insulating material commonly used for a PCB, and may include, for example, pre-impregnated composite fibers (pre-preg), an epoxy resin, or the like.

The PCB 120 according to the embodiment of the present invention may be formed by cutting a portion of at least one of the plurality of circuit layers through a press process or a punching process, and stacking the plurality of insulating and circuit layers in an alternating manner, on both surfaces of a portion of the circuit layer remaining subsequently to being cut.

The PCB 120 formed by such a manufacturing process may have a groove 125 formed in a direction perpendicular to a direction in which the insulating and circuit layers are stacked, for example, a thickness direction of the PCB 120.

The groove 125 of the PCB 120 may be formed to have a width the same as a width of the flange 185. The flange 185 may be inserted into the groove 125 of the PCB 120 to thereby be fixedly attached thereto by an adhesive member 127.

When the flange 185 is inserted into the groove 125 of the PCB 120 and is fixed thereto by the adhesive member 127, a component or a circuit pattern may be mounted on an upper surface and a lower surface of the PCB 120 corresponding to areas of the PCB 120 into which the flange 185 is inserted. Accordingly, since a space of the PCB 120 for allowing the mounting thereon may be secured, an overall size of the PCB 120 may be decreased.

Further, since the flange 185 formed of a material having relatively excellent heat dissipation characteristics is inserted into an interior of the PCB 120, the external dissipation of heat generated in the PCB 120 may be relatively readily achieved through the use of the flange 185.

FIG. 8 is an enlarged cross-sectional view illustrating a PCB and a flange according to an embodiment of the present invention. Among descriptions pertaining to a PCB and a flange according to another embodiment of the present invention, a repeated description the same as that of the PCB and the flange according to the embodiment of the present invention described hereinbefore will be omitted for conciseness.

In reference to FIG. 8, a PCB 120 may have a multilayer structure in which a plurality of circuit layers 121 and a plurality of insulating layers 123 are stacked in an alternating manner, and may have a groove 125 formed in a direction perpendicular to a direction in which the circuit and insulating layers 121 and 123 are stacked, for example, a thickness direction of the PCB 120. A flange 185 may be inserted into the groove 125 of the PCB 120 to thereby be fixedly attached thereto by an adhesive member 127.

In addition, the PCB 120 may have a s-hole 129 exposing portions of the flange 185 inserted into the groove 125. The via-hole 129 may be formed in a direction the same as the direction in which the circuit and insulating layers 121 and 123 are stacked. The via-hole 129 may be formed, although not exclusively, based on a size of the flange 185 to be inserted into the PCB 120.

The via-hole 129 may be formed by forming a cavity on the PCB 120 and supporting the cavity by a support member 128. The support member 128 may be formed of an insulating material commonly used for a PCB.

The external dissipation of heat generated from a component or a circuit pattern mounted on an upper surface and/or a lower surface of the PCB 120 may be achieved relatively readily through a use of the flange 185.

As set forth above, according to embodiments of the present invention, the display device may secure the space of the PCB for allowing the mounting thereon by forming the groove on the PCB and inserting the flange into the groove, whereby an additional coupling process such as the conventional screw coupling process may be omitted. As a result, the size of the PCB may be decreased. Further, the flange may be inserted between the plurality of layers of the PCB, and accordingly, heat generated in the PCB may be efficiently dissipated toward the bottom chassis, and the like.

In addition, the display device according to the embodiments of the present invention may further include the via-hole exposing the portions of the flange inserted into the PCB, thereby efficiently dissipating heat generated in the PCB.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings.

What is claimed is:

1. A display device comprising:
a display panel;
a printed circuit board (PCB) disposed on at least a side portion of the display panel and including a plurality of circuit layers;
a bottom chassis accommodating the display panel therein; and
at least one flange protruding outwardly of the bottom chassis,
wherein at least one of the plurality of circuit layers has at least one groove, and the flange is inserted into the groove.

2. The display device of claim 1, wherein the groove is formed in a direction perpendicular to a direction in which the plurality of circuit layers are stacked.

3. The display device of claim 1, wherein the PCB is formed in a direction the same as the direction in which the plurality of circuit layers are stacked, and has a via-hole exposing portions of the flange.

4. The display device of claim 1, wherein the flange has a width substantially the same as a width of the groove.

5. The display device of claim 1, further comprising an adhesive member disposed between the groove and the flange.

6. The display device of claim 1, wherein the bottom chassis includes at least one of aluminum (Al), an Al alloy, magnesium (Mg), a Mg alloy, copper (Cu), a Cu alloy, and steel use stainless (SUS).

7. The display device of claim 1, wherein the flange includes at least one of Al, an Al alloy, Mg, a Mg alloy, Cu, a Cu alloy, and SUS.

8. The display device of claim 1, wherein the flange is formed of a material the same as a material forming the bottom chassis.

9. A display device comprising:
a display panel;
a printed circuit board (PCB) disposed on at least a side portion of the display panel, and including a plurality of circuit layers;
a bottom chassis accommodating the display panel; and
at least one flange coupled to the bottom chassis,
wherein at least one of the plurality of circuit layers has at least one groove, one end of the flange is inserted into the groove, and the other end of the flange is coupled to the bottom chassis.

10. The display device of claim 9, wherein the groove is formed in a direction perpendicular to a direction in which the plurality of circuit layers are stacked.

11. The display device of claim 9, wherein the flange has a width substantially the same as a width of the groove.

12. The display device of claim 9, wherein the PCB is formed in a direction the same as the direction in which the plurality of circuit layers are stacked, and has a via-hole exposing portions of the flange.

13. The display device of claim 9, further comprising an adhesive member disposed between the groove and the flange.

14. The display device of claim 9, wherein the bottom chassis includes at least one of aluminum (Al), an Al alloy, magnesium (Mg), a Mg alloy, copper (Cu), a Cu alloy, and steel use stainless (SUS).

15. The display device of claim 9, wherein the flange includes at least one of Al, an Al alloy, Mg, a Mg alloy, Cu, a Cu alloy, and SUS.

16. The display device of claim 9, wherein the flange is formed of a material the same as a material forming the bottom chassis.
